(19) United States
(12) Patent Application Publication
(10) Pub. No.: US 2014/0353929 A1
(43) Pub. Date: Dec. 4, 2014

(54) EXPANDING ARBOR

(71) Applicant: Schaublin SA, Delémont (CH)

(72) Inventor: René Motschi, Delemont (CH)

(73) Assignee: SCHAUBLIN SA, Delémont (CH)

(21) Appl. No.: 14/345,354

(22) PCT Filed: Sep. 17, 2012
(86) PCT No.: PCT/EP2012/068193

§ 371 Date: Mar. 17, 2014

Related U.S. Application Data
(60) Provisional application No. 61/535,679, filed on Sep. 16, 2011.

(30) Foreign Application Priority Data
Sep. 19, 2011 (EP) PCT/EP2011/066214

(51) Int. Cl. B23B 31/40

(52) U.S. Cl. CPC B23B 31/4006; B23B 2231/20; B23B 2270/20
USPC 279/2.03

(57) ABSTRACT

An expandable arbor for mounting a tool or work piece to a machine tool includes a mounting portion including a tubular section having conical exterior surface flaring outwardly towards a substantially closed end thereof. The arbor includes an opposing end having a plug removably disposed therein. The closed end has a finger extending axially therefrom. The mounting portion is configured to be rotatably coupled to a machine tool spindle and defines a keyway configured on a portion of an outer surface thereof. The arbor includes a clamping portion comprising an expandable sleeve slidably positioned over the finger. The finger is axially movable relative to and within the expandable sleeve. A nut is positioned over a portion of the expandable sleeve for axially retaining the expandable sleeve relative to the machine tool and allowing radial movement of the expandable sleeve. The finger is axially movable within the expandable sleeve between a clamped position and an unclamped position upon application and removal of a force to the conical exterior surface. In the clamped position, the expandable sleeve is radially expanded relative to the unclamped position.

### TECHNICAL FIELD

The present invention relates generally to arbors and, more particularly, to an arbor having an expandable sleeve for engaging an inner diameter of a tool or work piece.

### BACKGROUND

An arbor is a device on which an internal surface of an object such as a tool or work piece can be positioned for rotation. Arbors can be cylindrical to accommodate an internal diameter of an object, or they can include flat surfaces or be irregularly-shaped to receive any suitable internal surface of an object. One typical method of clamping an object onto the arbor involves inserting the arbor through a hole in the object, inserting a bolt through a washer, and securing the bolt into the arbor such that the object is captured between the washer and the arbor. Tolerances in the arbor, the object being clamped, and the bolt are such that once secured, the object is positioned substantially concentrically relative to the arbor so as to achieve a suitable degree of rotational accuracy when the object is rotated in preparation for being worked on or for performing work.

When the tool or work piece is mounted for rotation in a machine such as a lathe, the positioning of the tool or work piece in the lathe affects the ability to machine the work piece in an accurate manner. Positioning a work piece in a rotating machine tool so that the work piece can be machined within tight tolerances typically requires that at least a portion of the work piece be substantially coaxial with an axis of rotation of the machine tool. Once clamped into the machine, the work piece is adjusted to attain proper alignment and orientation. Where the work piece or portion of the work piece is cylindrical, the work piece is generally adjusted to achieve concentricity within a predetermined tolerance upon rotation of the work piece. The concentricity achieved with typical clamping using bolts and washers, as well as other methods of mechanical clamping, is often inadequate or compromised during rotation, thereby resulting in runout, which will detrimentally affect the finished work piece.

### SUMMARY

In one aspect, the present invention resides in an expandable arbor for rotatably mounting an object to a machine tool. The expandable arbor for includes a mounting portion including a tubular section having conical exterior surface flaring outwardly towards a substantially closed end of thereof. The arbor includes an opposing end having a plug removably disposed therein. The closed end has a finger extending axially therefrom. The mounting portion is configured to be rotatably coupled to a machine tool spindle and defines a keyway configured on a portion of an outer surface thereof. The arbor includes a clamping portion comprising an expandable sleeve slidably positioned over the finger. The finger is axially movable relative to and within the expandable sleeve. A nut is positioned over a portion of the expandable sleeve for axially retaining the expandable sleeve relative to the machine tool and allowing radial movement of the expandable sleeve. The finger is axially movable within the expandable sleeve between a clamped position and an unclamped position upon application and removal of a force to the conical exterior surface. In the clamped position the expandable sleeve is radially expanded relative to the unclamped position.

### BRIEF DESCRIPTION OF THE FIGURES

FIG. 1 is a perspective view of an expanding arbor, of the present invention.

FIG. 2 is a side view of an expanding sleeve of the expanding arbor of FIG. 1.

FIG. 3A is an exploded perspective view of the expanding arbor of FIG. 1.

FIG. 3B is a cross-sectional view of the expanding sleeve of FIG. 3A taken along line 3B of FIG. 3A.

FIG. 4 is a side view of the finger of the expanding arbor of FIG. 1.

FIG. 5 is an exploded perspective view of a split ring fitted around the expanding sleeve on the mounting portion.

FIG. 6A is a side sectional view of the expanding arbor of FIG. 1 showing a nut securing the split ring to the mounting portion.

FIG. 6B is a side sectional view of the expanding arbor of FIG. 6A shown comparatively in a clamped position and an unclamped position.

FIG. 7 is a partial cutaway view of the expanding arbor of FIG. 1 mounted in a collet housing in a spindle of a machine.

FIG. 8 is an exploded perspective view of an alternate embodiment of an expanding arbor.

FIG. 9 is a side sectional view of the mounting portion and the finger of the expanding arbor of FIG. 8.

FIG. 10 is an exploded perspective view of another embodiment of an expanding arbor according to the present invention.

FIG. 11A is an axial view taken along line 11-11 of FIG. 10 showing the flange of the expandable sleeve in a contracted position.

FIG. 11B is an axial view taken along line 11-11 of FIG. 10 showing the flange of the expandable sleeve in an expanded position.

FIG. 12 is a side sectional view of the expanding arbor of FIG. 10 showing a collet housing having a nut securing the split ring to the mounting portion.

### DETAILED DESCRIPTION

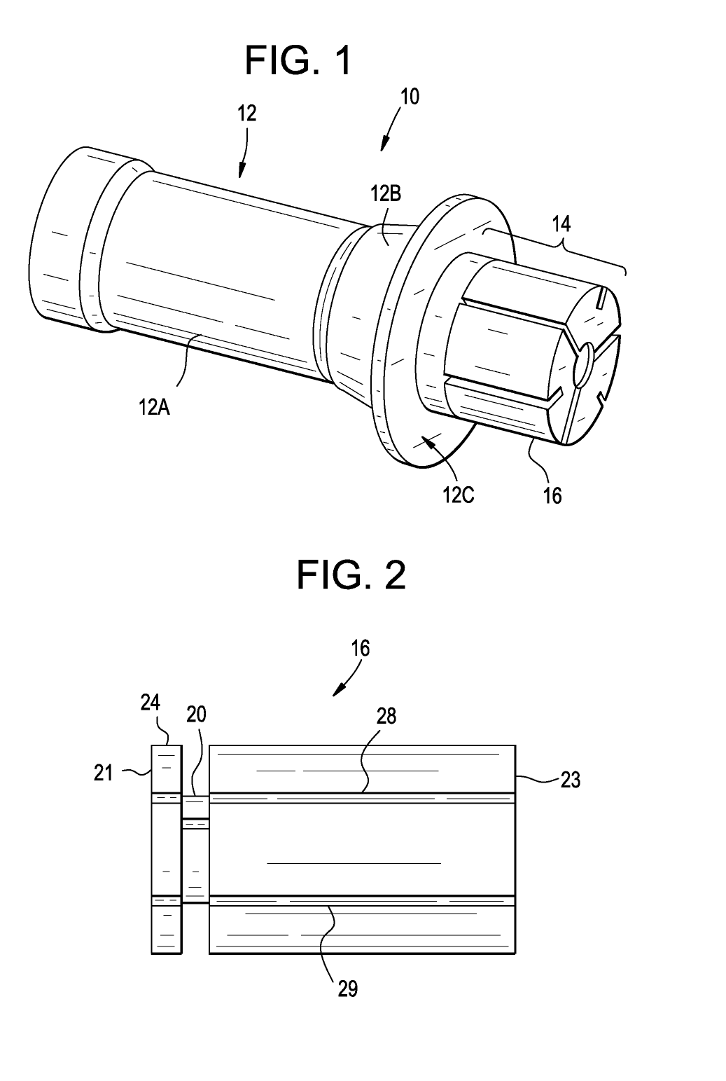

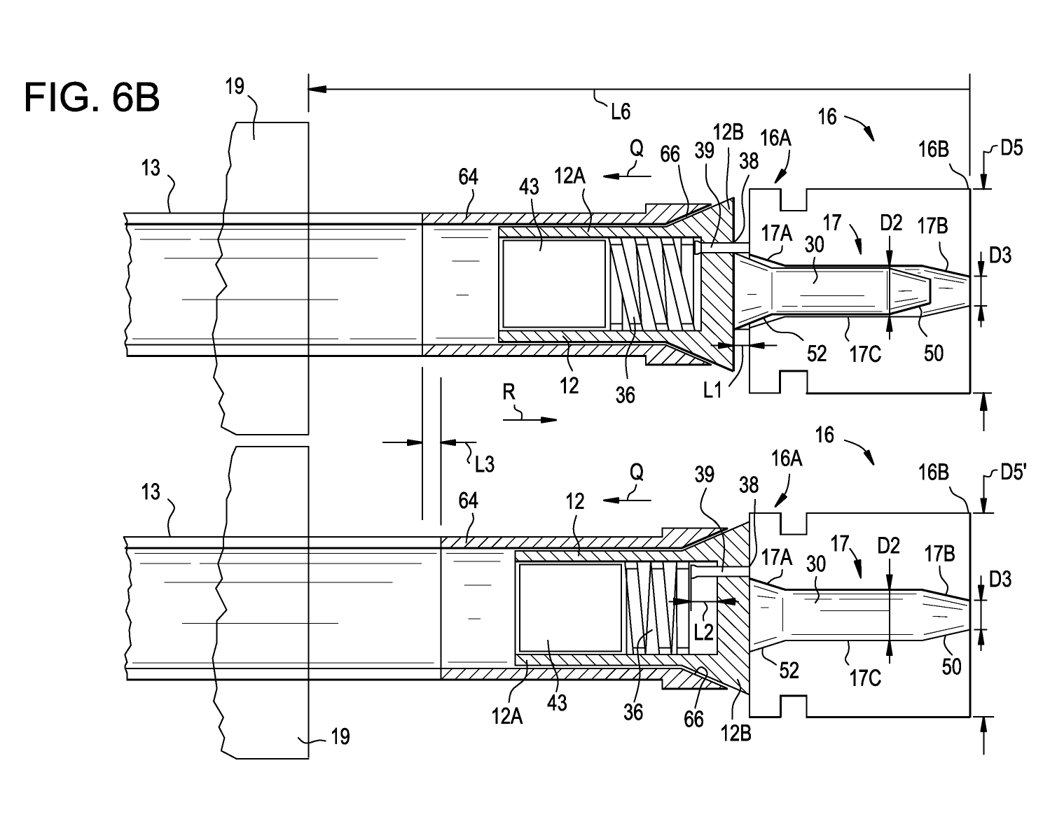

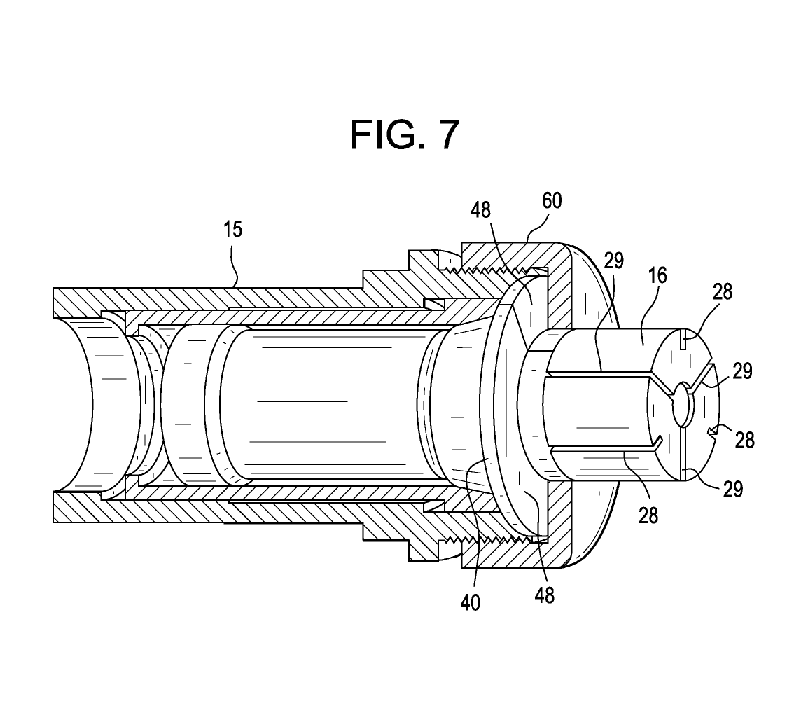

As shown in FIG. 1, an expanding arbor for rotatably clamping a work piece or tool to a machine tool (shown at 19 in FIG. 6A) is designated generally by the reference number 10 and is hereinafter referred to as “arbor 10.” The arbor 10 comprises a mounting portion 12 and a clamping portion 14 extending from the mounting portion. The mounting portion 12 includes a substantially continuous cylindrical tubular body portion 12A and an outwardly flared conical exterior surface 12B. In the illustrated embodiment, the clamping portion 14 is cylindrical and comprises an expandable sleeve 16 which, in use, is at least partially inserted into an aperture defined by the work piece, and as explained in greater detail below, is caused to engage a wall that defines the aperture. The mounting portion 12 is coupled to a tubular spindle (shown at 15 in FIGS. 6 and 7) forming part of the machine tool 19. During operation of the machine tool 19 causes the spindle 15 and thereby the arbor 10 to rotate. A compression tube 14 is disposed within the spindle 15 and is acuatable in an axial direction along an axis 32, as illustrated in FIG. 6A. The machine tool 19 may be a lathe or any similar type of machine tool having the rotating spindle 15. Although the arbor 10 is hereinafter described as receiving a work piece, it should be understood that the arbor 10 may also be used to receive a tool. While a cylindrical clamping portion 14 has been shown and described, the present invention is not limited in this regard as other shapes such as square, hexagonal, and the like can also be employed without departing from the broader aspects of the present invention.

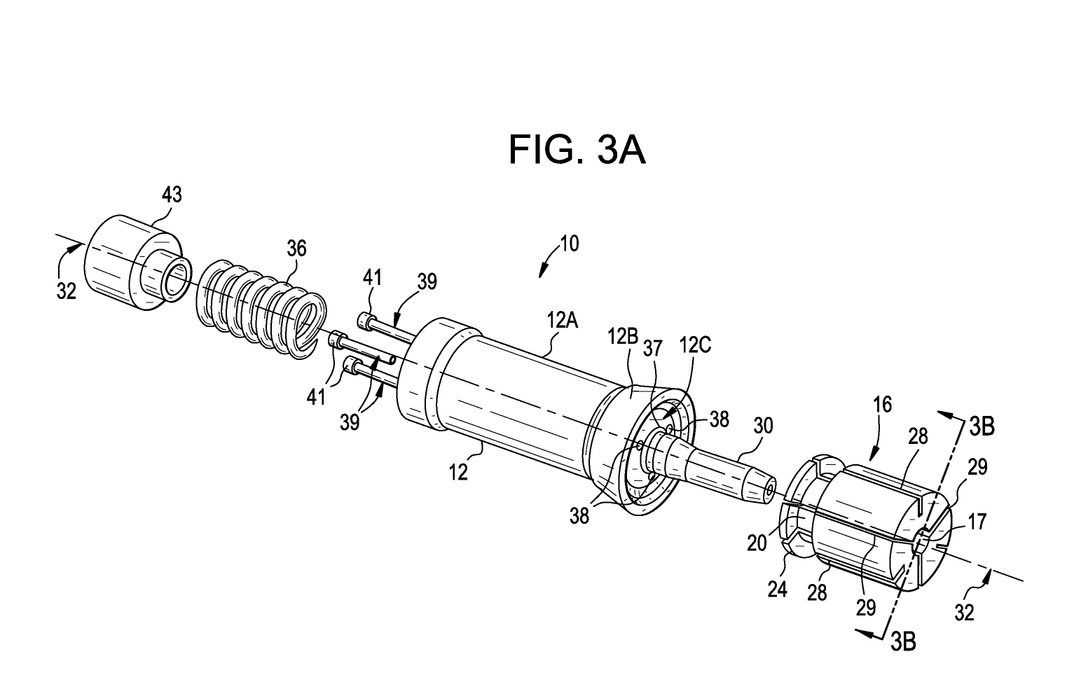

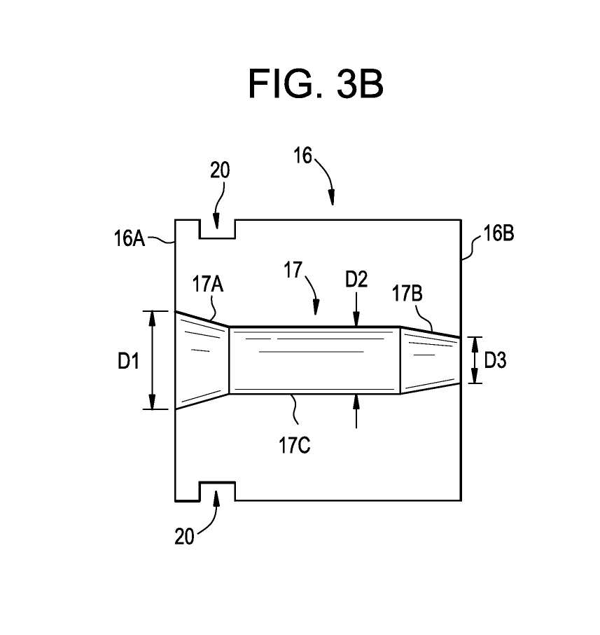

As shown in FIG. 2, the expandable sleeve 16 defines a groove 20 positioned proximate an end 21 thereof. A bore 17 (shown in FIG. 3) extends through the expandable sleeve 16. The expandable sleeve 16 defines a first plurality of slits 28 that extend longitudinally from the bore 17 at the end 21 through a flange 24 portion and along the expandable sleeve and terminate short of the bore at the second end 23. The expandable sleeve 16 also defines a second plurality of slits 29 that extend longitudinally from the bore 17 at the second end 23 and terminate short of the bore at the end 21. As will be explained in detail below, the slits 28, 29 facilitate the radial expansion of the sleeve to allow the expandable sleeve to expand and engage a work piece or tool and grippingly retain the work piece or tool on the sleeve. Materials from which the expandable sleeve 16 can be formed include, but are not limited to, steel, hardened steel, titanium, and the like. The surfaces of the expandable sleeve 16 on which the work piece is received may be coated, grooved, or smooth.

As shown in FIG. 3A, the expandable sleeve 16 is received over a finger 30 forming part of the clamping portion 14. In the illustrated embodiment, the finger 30 is integrally formed with and extends outwardly from the mounting portion 12 of the arbor 10 and along an axis 32. Expandable sleeves of different outside diameters can also be received over the finger 30 to accommodate work pieces having various sizes of internal diameters. Referring to FIG. 3B, the expandable sleeve 16 defines a first end 16A and a second end 16B wherein the bore 17 extends from the first end 16A to the second end 16B. The bore 17 defines a first conical portion 17A proximate the first end 16A. The first conical portion 17A flares outwardly toward the first end 16A. The bore 17 defines a second conical portion 17B proximate the second end 16B. The second conical portion 17B flares inwardly toward the second end 16B. The first conical portion 17A and the second conical portion 17B are in communication with one another via a cylindrical portion 17C. The first conical portion 17A defines a bore having a first diameter D1 and a truncated end portion having a second diameter D2. The cylindrical portion 17C also has the second diameter D2. The second conical portion 17B defines a base having the second diameter D2 and a truncated end portion having a third diameter D3. First, second and third diameters D1, D2, and D3, respectively, define relative diameters such that D1>D2>D3.

Referring again to FIG. 3A, holes 38 are located in a surface 37 of the mounting portion 12 equidistantly about the axis 32. Extracting pins 39 are positioned to slide in each hole 38, each extracting pin comprising a head 41 that, when the extracting pins translate through the holes 38, prevents the extracting pins from sliding completely through the holes 38. A compression spring 36 is located inside the mounting portion 12 to urge the extracting pins 39 through the holes 38 and axially away from the mounting portion 12. The spring 36 is positioned in the mounting portion 12 and retained therein via a closing plug 43 threadedly engaged in the mounting portion. Thus the mounting portion 12 defines a fully enclosed interior area 12F defined by the continuous tubular body portion 12A, the conical exterior surface 12B, the closed end 12C, the closing plug 43 and the pins 39 being slidingly engaged in the holes 38. While the finger 30 has been shown and described as being integrally formed with the mounting portion 12, the present invention is not limited in this regard as the finger can also be threaded onto or otherwise coupled to the mounting portion. In the illustrated embodiment, the mounting portion 12 circumferentially encloses the spring 36 and the extracting pins 39.

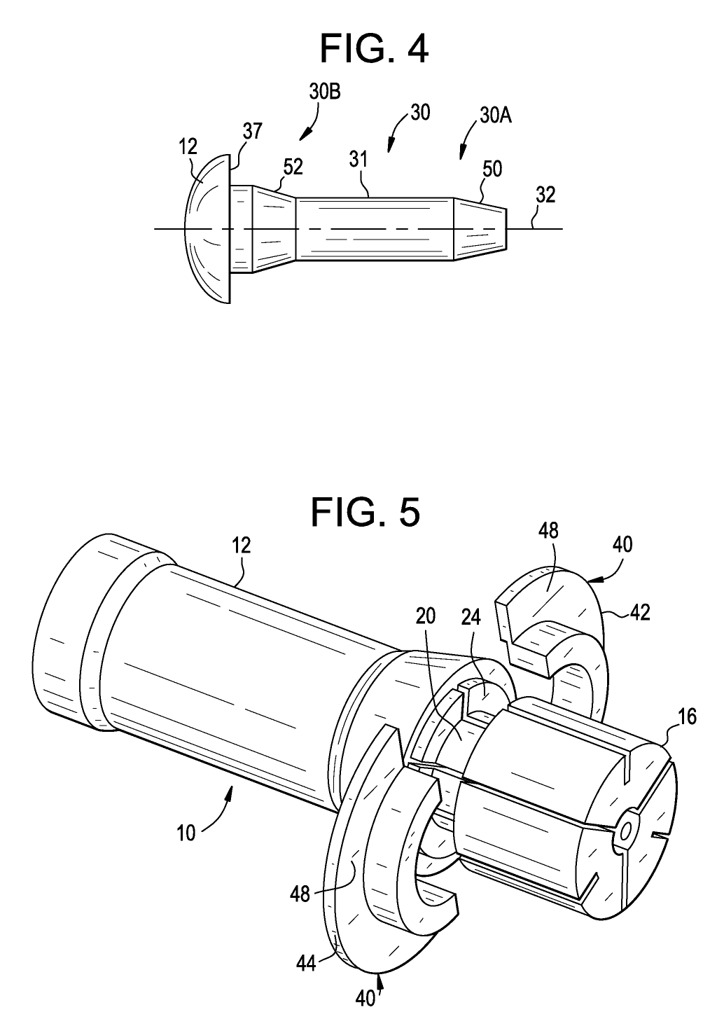

As shown in FIG. 4, the finger 30 is defined by a shaft portion 31 having a first tapered portion 50 proximate a distal end 30A of the finger 30 and a second tapered portion 52 proximate a base 30B of the finger 30. The present invention is not limited in this regard, however, as only the first tapered portion 50 may be employed depending on the work piece being mounted. Incorporation of the second tapered portion 52 at the base of the finger 30, however, allows the expandable sleeve 16 to expand in a more uniform manner, e.g., substantially the same amount at both ends 16A and 16B.

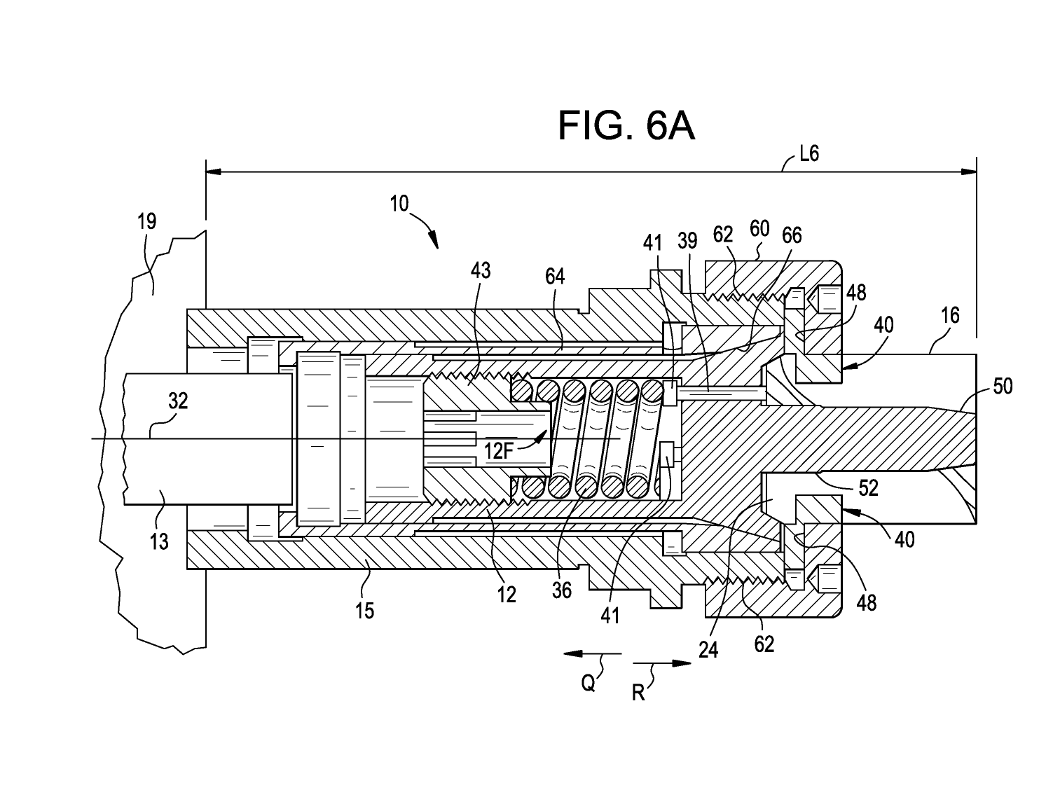

As shown in FIG. 5, once the expandable sleeve 16 is received over the finger 30 and is pushed in the direction of the mounting portion 12, the flange 24 engages end portions of the extracting pins 39 extending out of the holes 38. A split ring 40 is fitted around the expandable sleeve 16. The split ring 40 comprises a first half 42 and a second half 44, each of which is fit around the expandable sleeve 16 in the groove 20. Each half 42 and 44 of the split ring 40 is configured to define a surface 48. While the split ring 40 is shown and described as being in the halves 42 and 44, the present invention is not limited in this regard as the split ring may be sectioned in to any number of segments either symmetrically or asymmetrically.

As shown in FIGS. 6A and 7, a nut 60 is received over the expandable sleeve 16 and against the surfaces 48 of the split ring 40. The nut 60 is substantially cup-shaped and includes a hole therein to allow the cylindrical portion of the expandable sleeve 16 to be received therethrough. The flange 24, being larger in diameter than the hole through the nut 60, does not pass through the nut. The nut 60 also includes an internal thread 62 that is receivable on an external thread on the spindle 15 of the machine into which the mounting portion 12 is inserted. The nut 60 prevents axial movement of the expandable sleeve 16 relative to the machine 19 so that an axial length L6 between the expandable sleeve 16 and the machine 19 is fixed. The nut 60 and split ring 40 allow radial movement of the expandable sleeve 16. Referring also to FIGS. 3B and 4, the finger 30 extends into the bore 17 of the expanding sleeve 16 so that the first tapered portion 50 slidingly engages the second conical portion 17B axially outward from the nut 60; and the second tapered portion 52 slidingly engages the first conical portion 17A axially inward of the surface 48 of the split ring 40 and radially inwardly with respect to the nut 60.

To clamp a work piece on the arbor 10, the arbor 10 is first mounted onto the spindle 15. The expandable sleeve 16 is placed through the nut 60 and the assembly is introduced into the collet housing 64 and fit against the compression spring 36. The nut 60 is tightened onto the spindle 15 putting the expandable sleeve 16 in its proper position. Tightening the nut 60 onto the spindle 15 urges the split ring 40 against the extracting pins 39 protruding from the holes 38, thereby pushing the flange 24 against the mounting portion 12 of the arbor 10 and pushing the arbor into a collet housing 64 located in the spindle and displacing the extracting pins 39 in the general direction of the arrow Q. As a result, the arbor 10 is mounted onto the machine wherein the nut 60 holds the expandable sleeve 16 in position by fixing the expandable sleeve 16 with the split ring 40. Once mounted onto the machine, the expandable sleeve 16 and the split ring 40 do not move axially with respect to the spindle 15; they are fixed in position relative to the machine 19 at a distance L6, as shown in FIG. 6A.

As illustrated in FIGS. 6A and 6B (FIG. 6B is shown without the nut 60 and split ring 40 for clarity only) machine drawbar or compression tube 13 that is axially movable and rotatable is activated in the axial direction shown by the arrow R thereby pushing the collet housing 64 together with the mounting portion 12 towards the expandable sleeve 16. The collet housing 64, through a tapered surface 66, pushes against the conical surface 12B of the mounting portion 12 and forces the finger 30 into the bore 17 of the expanding sleeve 16. As described above with reference to FIGS. 3B, 4 and 6B, the first tapered portion 50 slidingly engages the second conical portion 17B and the second tapered portion 52 slidingly engages the first conical portion 17A which causes the expanding sleeve 16 to expand radially outward and engage the work piece. By engaging both the first conical portion 17A and the second conical portion 17B of the bore 17 in the expanding sleeve 16, the movement of the finger 30 causes the expanding sleeve 16 to expand uniformly radially outward from the axis 32 to a diameter D5′ referred to generally as a clamped position 1 in FIG. 6B.

To unclamp the work piece, the compression tube 13 is deactivated thereby releasing the collet housing 64 together with the mounting portion 12. The spring 36 urges the extracting pins 39 in the direction R, which in turn urges the mounting portion 12 to move away from the expandable sleeve 16 in the direction shown by the arrow Q. As the expandable sleeve 16 radially contracts to a diameter D5, referred to as an unclamped position 2 as shown in FIG. 6B. In the unclamped position 2 the work piece is released. The radial expansion of the expanding sleeve 16 from the diameter D5 to the diameter D5′ is caused by the wedging of the finger 30 into the bore 17 of the expanding sleeve 16. The diameter D5′ is greater than the diameter D5. The spring 36 releases collet housing 64 and the mounting portion 12 from clamped position thereby moves the collet housing 64 and the mounting portion 12 in the direction indicated by the arrow Q as a result of deactivation of the compression tube 13 in the axial direction Q. The extracting pins 39 and the holes 38 are positioned circumferentially symmetrically so that the expandable sleeve 16 is urged squarely away from the mounting portion 12 and the surface 37 during unclamping. While the extracting pins 39 and the holes 38 are shown and described as being positioned circumferentially symmetric, the present invention is not limited in this regard as the extracting pins 39 and the holes 38 may be positioned in any configuration generally circumferentially about the axis 32.

The unclamped position 1 and the clamped position 2 of the collet housing 64, the mounting portion 12, the finger 30 and the expandable sleeve 16 is shown in FIG. 6B relative to one another. Upon activation of the compression tube 13 in the axial direction R by a distance L3, the collet housing 64 together with the mounting portion 12 is pushed axially toward the expanding sleeve 16 and the finger 30 is moved axially into the bore 17 by a distance L1 and causing the spring 36 to compress a distance L2. The activation of the compression tube 13 in the direction R causes the bores 38 in the closed end 12C of the mounting portion 12 to slide along the extracting pins 39 by a distance L1. Thus the activation of the compression tube 13 in the direction R thereby causing the expanding sleeve 16 to expand radially outward to the diameter D5′ and engage the work piece (not shown). In one embodiment the distances L1, L2 and 13 are about equal.

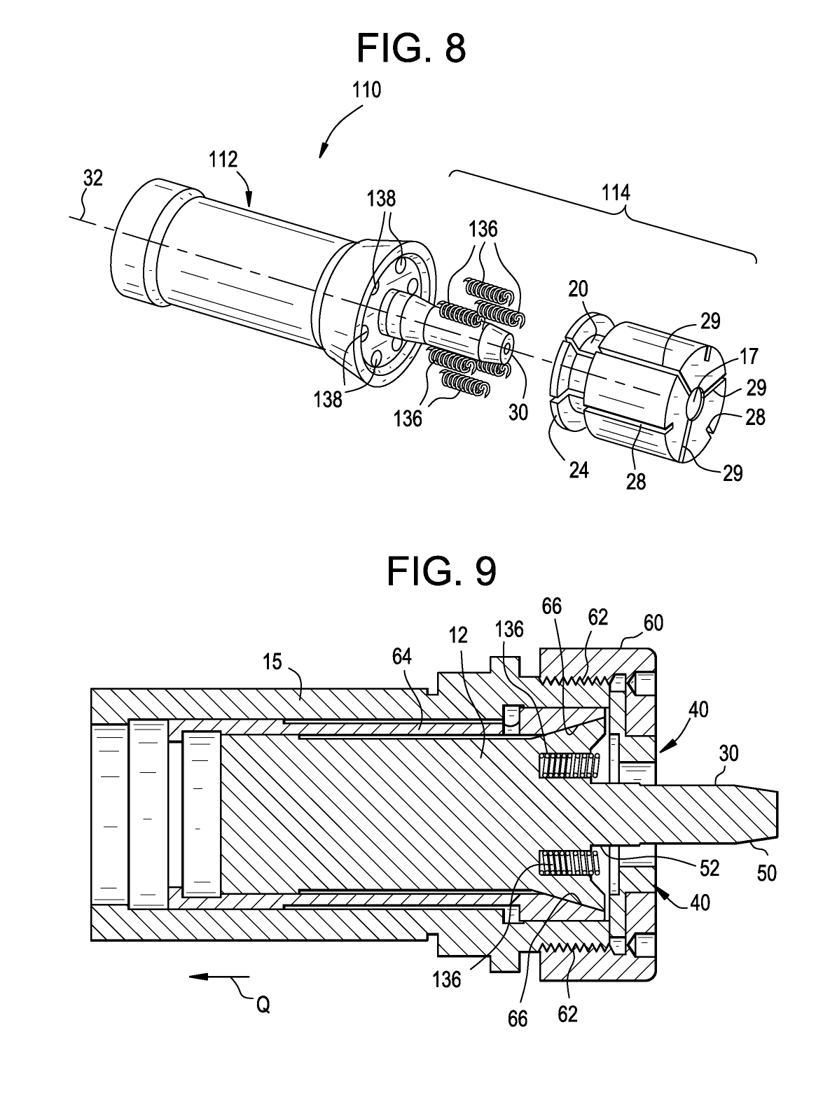

Referring now to FIG. 8, another embodiment of the expandable arbor is designated generally by the reference number 110 and is hereinafter referred to as “arbor 110.” The arbor 110 comprises a mounting portion 112 and a clamping portion 114 extending outwardly from the mounting portion, the clamping portion comprising an expandable sleeve 16 similar to that with regard to arbor 10 mountable over a finger 30. Holes 138 are located in a surface 137 of the mounting portion 112 equidistantly about an axis 32 extending longitudinally through the arbor 110. Springs 136 are located in each of the holes 138 such that a portion of each spring extends out of the hole. Upon receiving the expandable sleeve 16 over the finger 30, the portions of each spring 136 extending out of the holes 138 are engaged by the end 21 of the flange 24.

As shown in FIG. 9, a split ring 40 is placed around the expandable sleeve 16. A nut 60 is received over the expandable sleeve 16 and against surfaces 48 of the split ring 40. As with arbor 10, clamping a work piece on the arbor 110 involves mounting the work piece on the expandable sleeve 16 and tightening the nut 60 onto the spindle 15 to urge the split ring 40 in a forward direction. Upon continued urging of the split ring 40, the split ring engages the portions of the springs 136 protruding from the holes 138. Further tightening of the nut 60 compresses the springs 136, pushes the flange 24 against the mounting portion 112, and pushes the arbor 110 into the collet housing 64 located in the spindle 15. Still further tightening of the nut 60 further draws the flange 24 against a tapered surface 66 in the collet housing 64. As the flange 24 is drawn against the tapered surface, the progressive engagement of the flange and the tapered surface 66 causes the expandable sleeve 16 to move radially outwardly to engage and releasably retain a work piece. In configurations in which the second tapered portion 52 is incorporated into the finger 30, the slits 28 allow for additional radial expansion of the expandable sleeve 16 proximate the end thereof.

To unclamp the work piece the compression tube 13 is deactivated in the direction Q and the springs 136 urge mounting portion 12 away from the expandable sleeve 16. The slits 28, 29 allow the expandable sleeve 16 to contract in size across the diameter thereof. As the expandable sleeve 16 contracts in size across the diameter, the work piece is released.

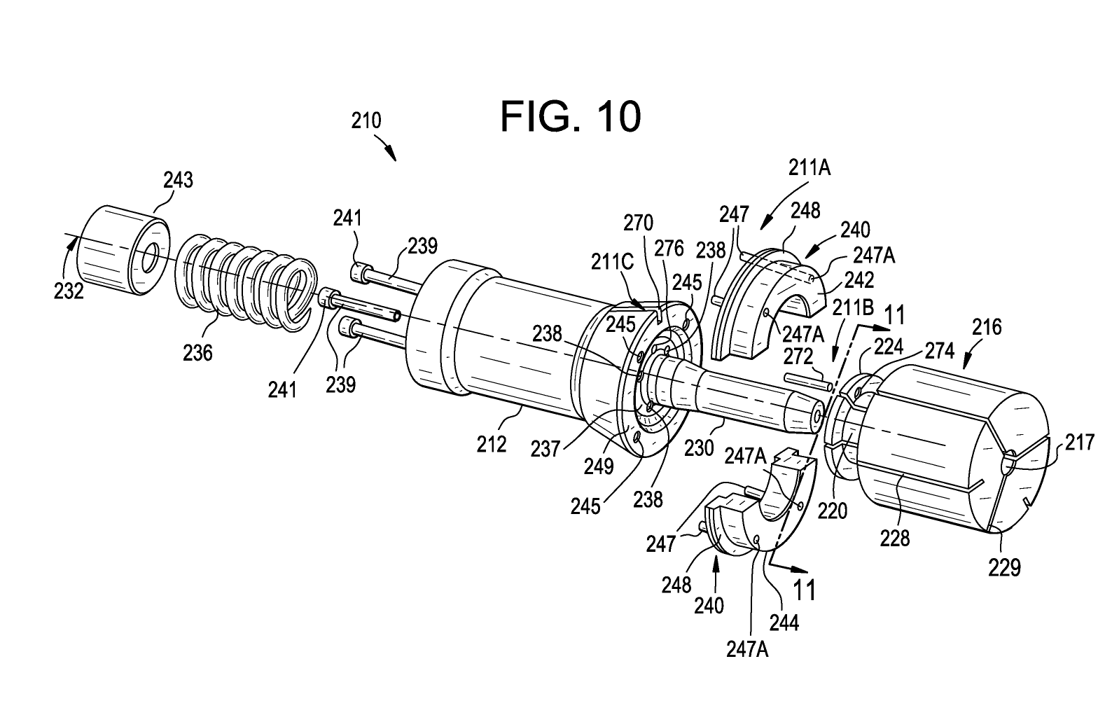

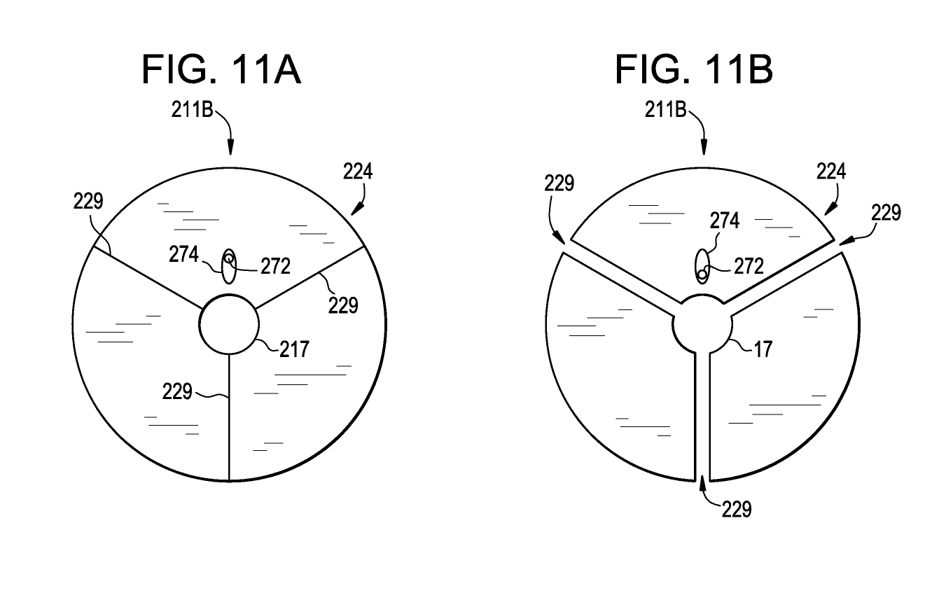

Referring now to FIGS. 10 and 11A, another embodiment of the expandable arbor is designated generally by the reference number 210 and is hereinafter referred to as “arbor 210.” The arbor 210 comprises a mounting portion 212 and three (3) positioning features 211A, 211B and 211C configured to prevent the mounting portion 212 from rotating, becoming ajar and/or slipping while the arbor 212 is being assembled and positioned on the machine spindle 215, as described in detail below. The mounting portion 212 includes a tubular body portion 212A and an outwardly flared conical surface 212B. An expandable sleeve 216 is received over a finger 230 having a first tapered portion 250 and a second tapered portion 252. The expandable sleeve 216 defines a groove 220, a bore 217 that extends through the expandable sleeve 216, and a first plurality of slits 228 that extend longitudinally from the bore 217 through a flange 224 and along the expandable sleeve 216 terminating short of the bore 217. The expandable sleeve 216 also defines a second plurality of slits 229 that extend longitudinally from the bore 217. Holes 238 are located in a surface 237 of the mounting portion 212 equidistantly about an axis 232. Extracting pins 239 are positioned to slide in each hole 238, each extracting pin comprising a head 241 that, when the extracting pins 239 translate through the holes 238, prevents the extracting pins from sliding completely through. A spring 236 is located inside the mounting portion 212 to urge the extracting pins 239 through the holes 238. The spring 236 is positioned in the mounting portion 212 and retained therein via a closing plug 243 threadedly engaged in the mounting portion 212.

The first positioning feature 211A is incorporated into the arbor 210 wherein a split ring 240 comprises a first half 242 and a second half 244, each of which is fit around the expandable sleeve 216 in the groove 220. Each half 242 and 244 of the split ring 240 is configured to define a surface 248. The first half 242 and the second half 244 of the split ring 240 each have two pins 247 extending therefrom. A first end of each pin 247 is positioned within a bore 247A of the first half 242 and the second half 244 of the split ring 240, for example by a press-fit. A second end of each pin 247 extends axially outward from the first half 242 and the second half 244 of the split ring 240 and engages a corresponding hole 245 defined in face 249 of the mounting portion 212. As a result, the expandable sleeve 216 is secured against rotation and slippage with respect to the mounting portion 212.

The pins 247 extending respectively from the first half 242 and the second half 244 of the split ring 240 define a substantially cylindrical configuration for convenience of assembly; however, the configuration of the pins 247 is not limited to the configuration described herein as any suitably robust configuration that provides the functionality described is considered within the scope of the invention. While two pins 247 extending from each half 242 and 244 of the split ring 240 and the corresponding holes 245 in the mounting portion 212 have been shown and described with respect to the first positioning feature 211A, the present invention is not limited in this regard as other protrusions, fasteners, integrally formed extensions and the like, as well as more or less pins and corresponding holes, can also be employed without departing from the broader aspects of the present invention.

The second positioning feature 211B further positions and secures the expandable sleeve 216 in the mounting portion 212. As shown in FIGS. 10, 11A and 11B, positioning feature 211B includes a mounting pin 272, having a substantially cylindrical configuration that is moveably received in a radially oblong hole 274 in the flange 224 in the expandable sleeve 216. When positioning the expandable sleeve 216 in the the mounting portion 212, the mounting pin 272 is fixedly engaged within a mounting pin hole 276 in the surface 237 of the mounting portion 212. The mounting pin 272 is moveably received within the hole 274 when the expandable sleeve 216 is further positioned and secured in the mounting portion 212. The oblong radial shape is required because the expandable sleeve 216 is expandable and will move slightly radially when clamping and/or unclamping, and this movement must not be impeded. As shown in FIG. 11A, the mounting pin 272 is positioned at a radially outward portion of the hole 274 when the flange 224 of the expandable sleeve 216 in a contracted position. As shown in FIG. 11B, the mounting pin 272 is positioned at a radially inward portion of the hole 274 when the flange 224 of the expandable sleeve 216 in an extended position.

The mounting pin 272 defines a substantially cylindrical configuration for convenience of assembly; however, the configuration of the mounting pin 272 is not limited to the configuration described herein as any suitably robust configuration that provides the functionality described is considered within the scope of the invention. While the mounting pin 272 and the corresponding holes 274 and 276 have been shown and described with respect to the second positioning feature 211B, the present invention is not limited in this regard as other protrusions, fasteners, integrally formed extensions and the like, as well as additional pins and corresponding holes, can also be employed without departing from the broader aspects of the present invention.

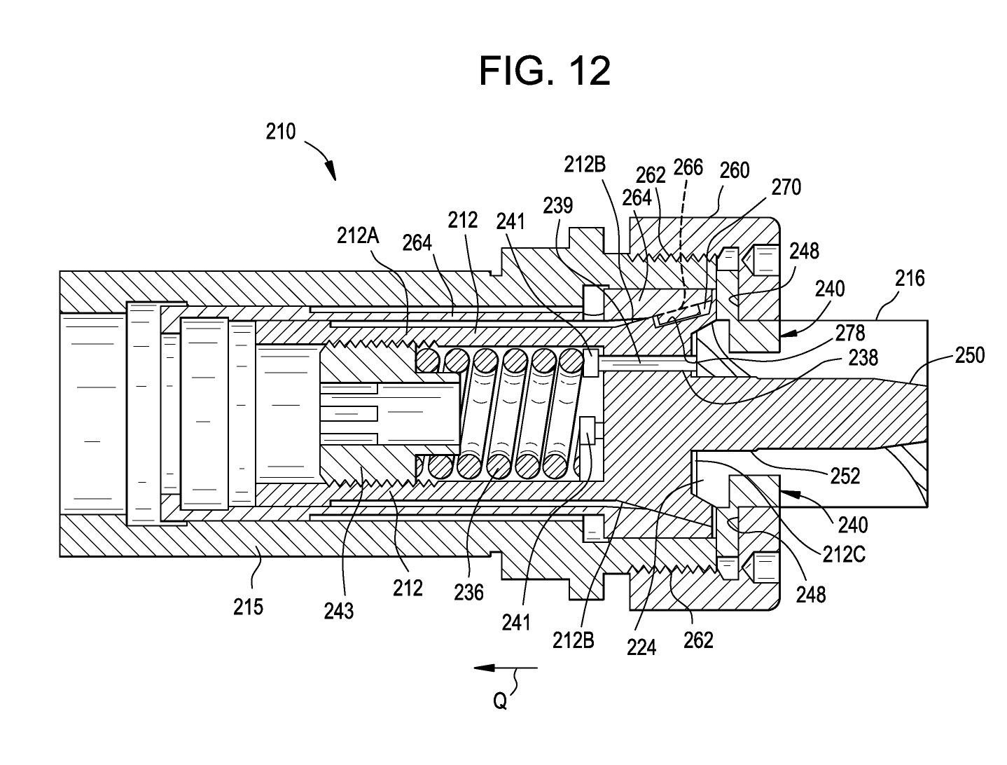

As shown in FIG. 12, a nut 260 is received over the expandable sleeve 216 and against the surfaces 248 of the split ring 240. The nut 260 is substantially cup-shaped and includes a hole therein to allow the cylindrical portion of the expandable sleeve 216 to be received therethrough. The flange 224, being larger in diameter than the hole through the nut 260, does not pass through the nut. The nut 260 also includes an internal thread 262 that is receivable on an external thread on the spindle 215 of the machine into which the mounting portion 212 is inserted.

As described above with respect to arbor 10, tightening the nut 260 onto the spindle 215 urges the split ring 240 against the extracting pins 239 protruding from the holes 238, thereby pushing the flange 224 against the mounting portion 212 of the arbor 210 and displacing the extracting pins 239 in the general direction of the arrow Q. The spindle 215 of the machine into which the mounting portion 212 is inserted includes a collet housing 264 located in the spindle 215. As shown in FIGS. 10 and 12, the third positioning feature 211C includes a protuberance, pin, key 278 or the like extending radially inward from a tapered surface 266 in the collet housing 264 and is received within a key way 270 defined in the mounting portion 212. Clamping and unclamping of a work piece is accomplished as described above with reference to arbour 10. The mounting portion 212 having the keyway 270 can selectively be used with a collet housing 264 having a key 278 for anti-rotation; or the same mounting portion 212 having the keyway 270 can be used with a collet housing 264 that does not have a key 278 thereby allowing for rotation of the mounting body 212 with respect to the collet housing 264.

The mounting portion 212 includes a tubular section 212A having conical exterior surface 212B flaring outwardly towards a substantially closed end 212C of thereof. The expandable arbor 210 includes an opposing end 12D having the closing plug 243 removably disposed therein. The closed end 212C has the finger 230 extending axially therefrom. The mounting portion 212 is configured to be rotatably coupled to a machine tool spindle and defines the keyway 270 configured on a portion of the conical exterior surface 212B. The clamping portion 214 comprises the expandable sleeve 216 slidably positioned over the finger 230. The finger 230 is axially movable relative to and within the expandable sleeve 216. A nut 260 is positioned over a portion of the expandable sleeve 216 for axially retaining the expandable sleeve 216 relative to the machine tool and allowing radial movement of the expandable sleeve 216. The finger 230 is axially movable within the expandable sleeve 216 between a clamped position and an unclamped position upon application and removal of a force to the conical exterior surface 212B. In the clamped position the expandable sleeve 216 is radially expanded relative to the unclamped position.

In one embodiment, the keyway 270 receives a key 278 extending from the machine tool to prevent rotation of the adjustable arbor 210 relative to the machine tool.

In one embodiment, the split ring 240 fitted around a portion of the expanding sleeve 216, the split ring 240 being coupled to the mounting portion 216 via the nut 260. In one embodiment, the split ring 240 defines at least one first bore 247A axially extending at least partially therethrough and the closed end 212C of the mounting portion 212 defines at least one second bore 238 extended at least partially therein, and where in a pin 247 is removably disposed the first bore 247A and/or the second bore 238.

In one embodiment, the expandable sleeve 216 is substantially cylindrical and includes a plurality of slits 228 longitudinally arranged therein. The slits 228 are effective to allow portions of the expandable sleeve 216 to radially move relative to one another to allow the expandable sleeve 16 to expand as the finger 30 is inserted axially into the expandable sleeve 216. In one embodiment, the expandable sleeve 216 further includes a flange 224 located at an end thereof and a groove 220 located adjacent to the flange. The groove 220 is configured to receive the split ring 240 therein.

In one embodiment, the spring 236 is contained in and circumferentially surrounded by the mounting portion 212. The extracting pins 239 are in communication with the spring 326. The extracting pins 239 are slidably located at least partially in the mounting portion 216 and extending through respective bores 238 extending through the closed end 212C, to urge the mounting portion 212 away from the expandable sleeve 216.

In one embodiment, the mounting pin 272 is fixedly engaged within the mounting pin hole 276 in the second end 212C of the mounting portion 212 and is moveably received within the radially oblong hole 274 formed in an axial end of the expandable sleeve 216.

Although this invention has been shown and described with respect to the detailed embodiments thereof, it will be understood by those skilled in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the appended claims.

1.-11. (canceled)

12. An expandable arbor for mounting a tool or work piece to a machine tool, the expandable arbor comprising:
a mounting portion comprising a tubular section having conical exterior surface flaring outwardly towards a substantially closed end thereof and an opposing end, the closed end having a finger extending axially therefrom, the mounting portion being configured to be rotatably coupled to a machine tool spindle; and
a clamping portion comprising,
an expandable sleeve slidably positioned over the finger, the finger being axially movable relative to and within the expandable sleeve, wherein the expandable sleeve is substantially cylindrical and includes a plurality of slits longitudinally arranged therein, the slits being effective to allow portions of the expandable sleeve to radially move relative to one another to allow the expandable sleeve to expand as the finger is inserted axially into the expandable sleeve, the expandable sleeve comprising a flange located at an end thereof,
a nut positioned over a portion of the expandable sleeve for axially retaining the expandable sleeve to the machine tool spindle and allowing radial movement of the expandable sleeve,
wherein the finger is axially movable within the expandable sleeve between a clamped position and an unclamped position upon application and removal of a force to the conical exterior surface; and
wherein in the clamped position the expandable sleeve is radially expanded relative to the unclamped position,
wherein the opposing end has a plug removably disposed therein,
wherein the mounting portion defines a keyway configured on a portion of an outer surface thereof,
wherein the expandable sleeve comprises a groove located adjacent to the flange, and
wherein the clamping portion comprises a split ring fitted around the expandable sleeve in the groove, the split ring being coupled to the mounting portion via the nut.

13. The expandable arbor of claim 12, wherein the keyway receives a key extending from the machine tool to prevent rotation of the adjustable arbor relative to the machine tool.

14. The expandable arbor of claim 12, wherein the split ring defines at least one first bore axially extending at least partially therethrough and the closed end of the mounting portion defines at least one second bore extended at least partially therein, and wherein a pin is removably disposed in at least one of the first bore and the second bore.

15. The expandable arbor of claim 12, wherein the finger comprises at least one tapered portion thereon.

16. The expandable arbor of claim 12, further comprising:
a spring contained in and circumferentially surrounded by the mounting portion;
a plurality of extracting pins in communication with the spring and, the extracting pins being slidably located at least partially in the mounting portion and extending through respective bores extending through the closed end, to urge the mounting portion away from the expandable sleeve.

17. The expandable arbor of claim 13, further comprising a plurality of springs located in a corresponding plurality of holes defined by a second end of the mounting portion, the plurality of springs being configured to urge the expandable sleeve toward the nut.

18. The expandable arbor of claim 12, further comprising a mounting pin that is fixedly engaged within a mounting pin hole in the closed end of the mounting portion and is moveably received within a radially oblong hole formed in an axial end of the expandable sleeve.

19. The expandable arbor of claim 12, the expandable sleeve further comprising:
a bore defined therethrough extending from an axial inward first end to an axially outward second end and adapted to receive the finger therein, the bore comprising,
a first conical portion proximate the first end, the first conical portion defining a first diameter D1 and a second diameter D2 wherein the first conical portion flares radially outwardly and axially inwardly from D2 to D1,
a second conical portion proximate the second end, the second conical portion defining the second diameter D2 and a third diameter D3 wherein the second conical portion flares radially outwardly and axially inwardly from D3 to D2,
a cylindrical portion in communication with the first conical portion and the second conical portion and defining the second diameter D2,
wherein the finger is axially movable in the bore between a clamped position and an unclamped position upon application and removal of a force to the conical exterior surface.

20. The expandable arbor of claim 19, the finger further comprising:
a shaft portion extending between a first tapered portion proximate an axially outward distal end and a second tapered portion proximate an axially inward base, the first tapered portion flaring radially outwardly and axially inwardly from the distal end to the shaft, the second tapered portion flaring radially outwardly and axially inwardly from the shaft to the base,
wherein, in the clamped position,
the finger distal end is received within the bore second end and the finger first tapered portion engages the bore second conical portion,
the finger shaft is received within and engages the bore cylindrical portion, and
the finger base is received within the bore first end and the finger second tapered portion engages the bore first conical portion.

21. The expandable arbor of claim 20, the radial expansion of the expandable sleeve from the clamped to the unclamped position comprising uniform expansion of the expandable sleeve.

22. The expandable arbor of claim 20, the expandable sleeve comprising the plurality of slits that extend axially therethrough, the radial expansion of the expandable sleeve from the clamped to the unclamped position comprising uniform expansion of the expandable sleeve.
